(19) United States
(12) Patent Application Publication
(10) Pub. No.: US 2021/0300166 A1
(43) Pub. Date: Sep. 30, 2021

(54) DOOR WEATHER STRIP

(71) Applicant: TOYODA GOSEI CO., LTD., Kiyosu-shi (JP)

(72) Inventors: Daiki Kajita, Kiyosu-shi (JP); Kiyotaka Tamaoki, Kiyosu-shi (JP); Yoshitaka Konishi, Kariya-shi (JP)

(21) Appl. No.: 17/206,612

(22) Filed: Mar. 19, 2021

(30) Foreign Application Priority Data
Mar. 27, 2020 (JP) 2020-057087

(51) Int. Cl. B60J 10/25; B60J 10/86; B60J 10/24

(52) U.S. Cl. CPC B60J 10/25; B60J 10/24; B60J 10/86

(57) ABSTRACT

A door weather strip having a fin portion provided to a corner portion in a rear portion of a door of a motor vehicle is provided. The fin portion is formed by molding and mounted so as to cover the inside of the motor vehicle in the corner portion. On the mounting surface side of the fin portion of the door weather strip, a drainage lip is provided. The drainage lip protrudes from the mounting surface to the outside of the vehicle and extends in a linear shape or an upward protruding arc shape from the front to the rear of the motor vehicle and further downward. The drainage lip does not come into contact with a rear end rib formed on the fin portion at a rear end of the motor vehicle, and a drainage recess is formed between the rear end rib and a door frame.

### CROSS REFERENCE TO RELATED APPLICATION

This application claims the priority benefit of Japanese Patent Application No. 2020-057087 filed on Mar. 27, 2020. The entirely of the above-mentioned patent application is hereby incorporated by reference herein and made a part of this application.

### BACKGROUND OF THE INVENTION

### (1) Field of the Invention

The present invention relates to a door weather strip for efficiently draining water that has entered between a door and a fin portion of the door weather strip in a corner portion of a door of a motor vehicle.

### (2) Description of Related Art

Generally, a door weather strip is mounted corresponding to a peripheral edge of a vehicle door. In a part corresponding to the upper side of the door, as shown in FIG. 8, a door weather strip 200 in which a hollow seal portion 230 (main seal) and a seal lip 260 (sub seal portion) are integrated by a connecting portion 235 may be attached to a door frame 140 and a retainer 150.

Further, in a door weather strip that is attached corresponding to the peripheral edge of the door, since the degree of bending becomes larger (the bending becomes steep) at each corner portion of the door and the shape of the corner portion is different for each vehicle, corner portions are shaped suitable for each vehicle by molding.

Furthermore, in a corner portion on the upper side of the door, in order to maintain the rigidity of the hollow seal portion in which the degree of bending increases, and to improve the appearance by covering the door members such as the bent part of the door frame at the corner, the door frame, the retainer, and the frame molding at the corners, a fin portion is likely to be formed.

By the way, when the door weather strip 200 in FIG. 8 is used, as shown in FIG. 7, in a fin portion 300 formed at the corner portion by molding, the tip portion from the connecting portion 235 is extended and formed to be larger, and is clipped to a mounting panel 170 although not shown in FIG. 7, rather than fitting a vehicle exterior mounting base portion 215 into the retainer 150 as shown in FIG. 8. Further, the upper tip portion of the fin portion 300 is bent to the outside of the vehicle to form a rib 255 having a shape in which the tip is split in two, and the rib 255 is fitted into a frame molding 160, whereby the space between the fin portion 300 and the frame molding 160 is sealed.

However, since the seal between the rib 255 and the frame molding 160 is not firm, there is a problem that water enters from between the rib 255 and the frame molding 160 due to high-pressure car washing or the like, and the water runs downward on the mounting surface 440 of the fin portion 300 and enters the inside of the vehicle.

Conventionally, in order to prevent the above-mentioned infiltrated water from entering the inside of the vehicle, a caulking sponge 470 is attached to the mounting surface 440 side of the fin portion 300 with double-sided tape.

Further, as another means for preventing the above-mentioned infiltrated water from entering the inside of the vehicle, the art of JP 2009-220750 A has been devised. The art of JP 2009-220750 A is as described below. As shown in FIGS. 9 and 10, JP 2009-220750 A includes a mounting bottom surface (mounting base portion) 210 to be mounted on the mounting portion of a door frame 140 of the motor vehicle, a body 220 located in the central portion, a hollow seal portion 230 that is located inside the body 220 and is elastically in contact with the body panel, a rear rib 240 that is located on outside the body 220 and is elastically in contact with the door frame 140, and a waterproof bead 250 that is provided between the hollow seal portion 230 and the rear rib 240 and is elastically in contact with the door frame 140. On the mounting surface of the fin portion 300 to be attached to the corner portion of the door frame 140, the inner peripheral side of the corner portion is provided with a wall portion 280 that has a protruding height to be in elastic contact with the door frame 140 and continuously hangs from the horizontal portion of the rear rib 240, and has a length that the lower end portion is close to the waterproof bead 250 and a discharge recess is formed between it and the waterproof beads 250.

### SUMMARY OF THE INVENTION

However, in the conventional art of attaching the caulking sponge 470 with double-sided tape, it is necessary to prepare the caulking sponge 470 as a separate body and attach it with double-sided tape. This causes problems that the cost is increased, the installation work is troublesome, and the productivity is poor.

In addition, while the art of JP 2009-220750 A is useful against infiltration of water from a specific direction, especially in a vehicle having a rear door of a shape in which the belt line largely rises at the rear of the vehicle or in which the belt line rises at the rear of the vehicle and the upper edge portion of the rear door falls down in an arc shape in the rear of the vehicle, which is increasing reflecting the variety of designs, with respect to the seal between the rib 255 and the frame molding 160, that is, the seal of an area having a certain length in the front-rear direction of the vehicle, it is impossible to prevent infiltration of water.

In order to solve the problems described above, the invention according to claim 1 is a door weather strip including a fin portion provided to a corner portion in a rear portion of a door of a motor vehicle. The fin portion is formed by molding and mounted so as to cover the inside of the motor vehicle in the corner portion. On the mounting surface side of the fin portion of the door weather strip, a drainage lip is provided. The drainage lip protrudes from the mounting surface to the outside of the motor vehicle and extends in a linear shape or an upward protruding arc shape from the front of the motor vehicle to the rear of the motor vehicle and further downward. The drainage lip does not come into contact with a rear end rib formed on the fin portion at a rear end of the motor vehicle, and a drainage recess is formed between the door frame and the rear end rib.

In the present invention of claim 1, on the mounting surface side of the fin portion of the door weather strip, a drainage lip that protrudes from the mounting surface to the outside of the motor vehicle and extends in a linear shape or an upward protruding arc shape from the front to the rear of the vehicle and further downward is provided. Therefore, even if water enters from between the rib and the frame molding due to high pressure car washing or the like, the drainage lip allows the water flowing downward on the mounting surface of the fin part can be guided to the rear end side of the fin portion.

Further, the drainage lip does not come into contact with the rear end rib formed at the rear end of the fin portion of the vehicle, that is, there is a space between the rear end of the drain lip and the rear end rib. Therefore, the water guided to the rear end of the fin portion by the drainage lip can be guided downward along the mounting surface of the fin portion by utilizing the space between the drainage lip and the rear end rib.

Further, since a drainage recess is formed between the rear end rib and the door frame, the space between the drainage lip and the rear end rib is used to allow the water guided downward along the mounting surface of the fin portion to be drained from the drainage recess.

Therefore, even when water enters from between the rib and the frame molding, it can be drained without using the above-mentioned caulking sponge, so that cost reduction and productivity improvement can be achieved.

The invention according to claim 2 is a door weather strip in which the tip of the drainage lip of the fin portion does not come into contact with an opposite member on the door side when the fin portion is attached to the corner portion of the door.

In the invention of claim 2, the tip of the drainage lip of the fin portion does not in contact with an opposite member on the door side when the fin portion is attached to the corner portion of the door. Therefore, it is possible to prevent the case where the drainage lip turns downward and warps downward and the water flows downward through between the drainage lip and the member on the door side which may occurs when the fin portion is in contact with the opposite member on the door side.

The invention according to claim 3 is a door weather strip in which, in a cross section of the fin portion in a vehicle width direction when the fin portion is attached to the corner portion of the door, when the tip of the drainage lip is defined as a tip A, an upper end of the root of the drainage lip is defined as an upper end B, a lower end of the root of the drainage lip is defined as a lower end C, a midpoint of a line segment BC connecting the upper end B and the lower end C is defined as a midpoint D, and a line segment connecting the midpoint D and the tip A is defined as a line segment DA, an angle α defined by the line segment DA and a horizontal line is 17 degrees or more and 50 degrees or less.

In the showering test method, an evaluation is also performed in a state where a vehicle is tilted, in order to detect water leakage that could not be detected by simply injecting water from various directions in a horizontal posture. For the tilt in the vehicle width direction, it is usually carried out by tilting the vehicle by 16.5 degrees.

In the invention of claim 3, when the tip of the drainage lip is defined as a tip A, an upper end of the root of the drainage lip is defined as an upper end B, a lower end of the root of the drainage lip is defined as a lower end C, a midpoint of a line segment BC connecting the upper end B and the lower end C is defined as a midpoint D, and a line segment connecting the midpoint D and the tip A is defined as a line segment DA, the angle α between the line segment DA and the horizon is 17 degrees or more. Therefore, even in the case where the vehicle is tilted, the tip of the drainage lip is located above the root with respect to the horizontal line. As a result, it is possible to prevent the water from dripping from the tip of the drainage lip and flowing downward, and to reliably guide the water to the rear end side of the fin portion.

By the way, since the drainage lip extends in a linear shape or an upward protruding arc shape from the front to the rear of the vehicle and further downward, it is necessary to secure a space for it in the fin portion. Further, for mounting the fin portion, for example, when mounting using a clip, it is necessary to form a clip base on the fin portion. Then, it is necessary to prevent interference between the tip of the drainage lip and the clip base. Further, in the base of the mounting member, water may drip onto the drainage lip in a granular shape. Therefore, it is preferable that there is a gap of about 2 mm between the tip of the drainage lip and the base of the mounting member.

If the angle α defined by the line segment DA and the horizontal line exceeds 50 degrees, it may be difficult to satisfy the above space requirement, which is not preferable. In addition, since the angle α becomes large and the height substantially protruding from the fin portion becomes low (the length of the line segment perpendicular to the mounting surface of the fin portion from the tip A of the drainage lip becomes short), the length of the drainage lip (line segment DA) needs to be increased to guide the water reliably. As a result, since it leads to cost increase and weight increase, it is not preferable.

The invention according to claim 4 is a door weather strip in which a plurality of drainage lips are formed. In the present invention of claim 4, since a plurality of drainage lips are formed, even when the infiltrated water overflows from the upper drainage lip due to the momentum and amount of the infiltrated water, the drainage lip formed below functions as a backup, and the water overflowing from the upper drainage lip can be reliably guided to the rear end side of the fin portion by the drainage lip formed below.

The invention according to claim 5 is a door weather strip in which the height of the drainage lip protruding from the mounting surface of the fin portion increases as it goes downward. In the invention of claim 5, the height of the drainage lip protruding from the mounting surface of the fin portion increases as it goes downward, so that even if the infiltrated water overflows from the upper drainage lip and drips due to the momentum and amount of the infiltrated water, the water can be reliably received by the drainage lip formed below, and can be reliably guided to the rear end side of the fin portion.

On the mounting surface side of the fin portion of the door weather strip, a drainage lip that protrudes from the mounting surface to the outside of the motor vehicle and extends in a linear shape or an upward protruding arc shape from the front to the rear of the vehicle and further downward is provided. Therefore, even if water enters from between the rib and the frame molding due to high pressure car washing or the like, the drainage lip allows the water flowing downward on the mounting surface of the fin part can be guided to the rear end side of the fin portion.

Further, the drainage lip does not come into contact with the rear end rib formed at the rear end of the fin portion of the vehicle, that is, there is a space between the rear end of the drain lip and the rear end rib. Therefore, the water guided to the rear end of the fin portion by the drainage lip can be guided downward along the mounting surface of the fin portion by utilizing the space between the drainage lip and the rear end rib.

Further, since a drainage recess is formed between the rear end rib and the door frame, the space between the drainage lip and the rear end rib is used to allow the water guided downward along the mounting surface of the fin portion to be drained from the drainage recess.

Therefore, even when water enters from between the rib and the frame molding, it can be drained without using the above-mentioned caulking sponge, so that cost reduction and productivity improvement can be achieved.

### BRIEF DESCRIPTION OF THE DRAWINGS

FIG. 1 is a front view of a rear door on the right side of a motor vehicle as viewed from the outside of the vehicle;

FIG. 2 is a front view of FIG. 1 as viewed from the inside of the vehicle, explaining the positional relationship between a rear door and a door weather strip;

FIG. 3 is a perspective view of a fin portion of a door weather strip according to an embodiment of the present invention as viewed from the mounting surface side;

FIG. 4 is a perspective view seen from a direction of the arrow in FIG. 2 when the door weather strip is attached;

FIG. 5 is a cross-sectional view taken along line X-X in FIG. 3 when the door weather strip is attached;

FIG. 6 is an enlarged view of a portion indicated by Z in FIG. 5;

FIG. 7 is a cross-sectional view when a fin portion of a conventional door weather strip is attached;

FIG. 8 is a cross-sectional view of a door weather strip attached to the upper side of a conventional door of a motor vehicle;

FIG. 9 is an external view of a fin portion of a conventional door weather strip as viewed from the mounting surface side (JP 2009-220750 A); and

FIG. 10 is a cross-sectional view showing assembly of a conventional door weather strip and a door frame (JP 2009-220750 A).

### DETAILED DESCRIPTION OF PREFERRED EMBODIMENTS

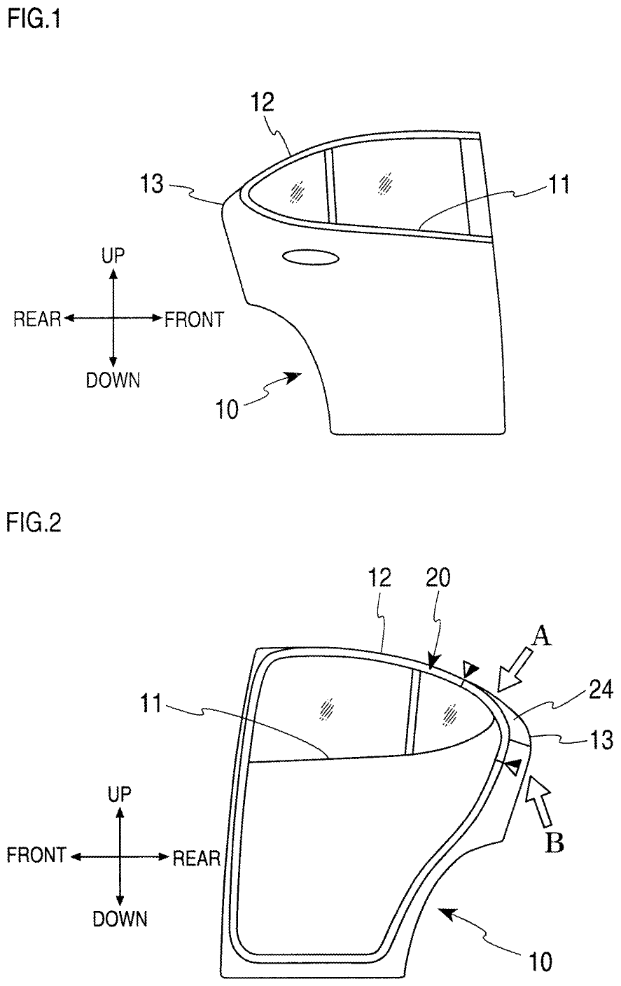

An embodiment of the present invention will be described with reference to FIGS. 1 to 6. FIG. 1 is a front view of a rear door 10 on the right side of a motor vehicle as viewed from the outside of the vehicle. Further, FIG. 2 is a front view of FIG. 1 as viewed from the inside of the vehicle, and particularly illustrates the positional relationship with the door weather strip 20. The present invention can be applied to a rear door on the left side, and further can be applied to a front door.

The door of FIG. 1 is the rear door 10 in which a belt line 11 has a shape of uprising at the rear of the vehicle, and an upper side 12 of the door has a shape that gently protrudes upward in an arc shape and goes downward toward the rear of the vehicle. As a result, a corner portion 13 of the rear door 10 is formed in the vicinity of the belt line 11. Then, as shown in FIG. 2, a fin portion 24 of the door weather strip 20 is formed by covering a rear corner portion 13 of the rear door 10 from the inside of the vehicle.

In FIG. 2, the fin portion 24 formed in the door weather strip 20 is formed by molding, and the front and rear (upper and lower in FIG. 2) portions of the fin portion 24 are formed by extrusion molding. The triangular marks shown in FIG. 2 indicate an extrusion-molded portion on the white side and a mold-molded portion on the black side.

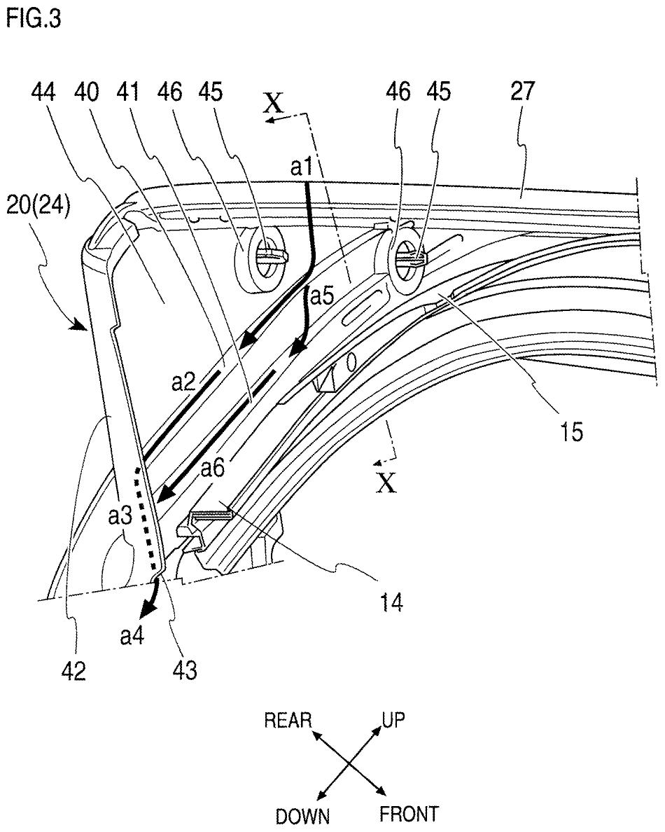

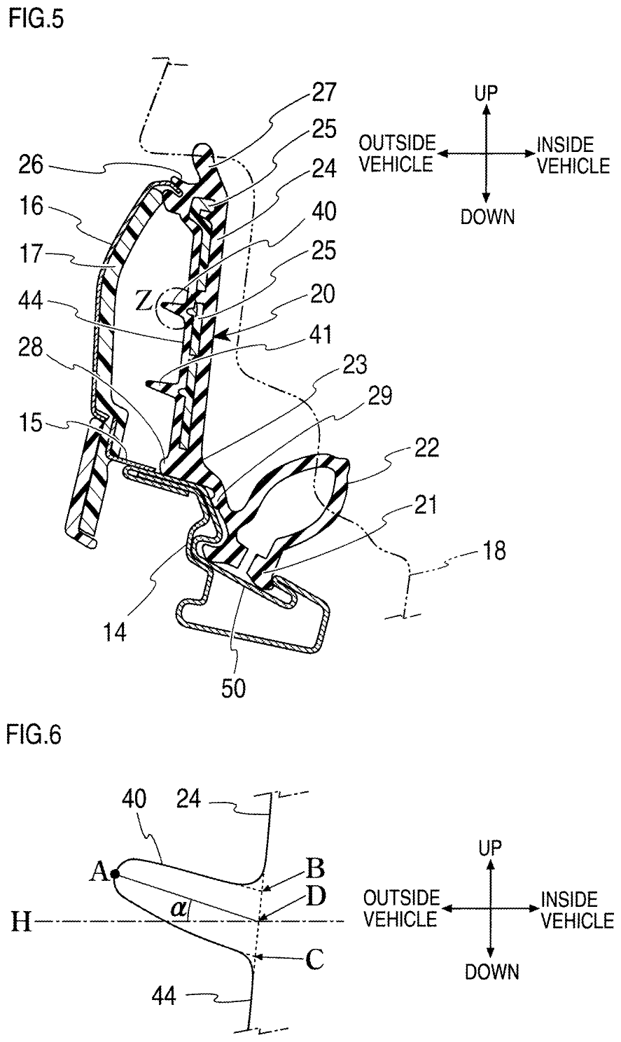

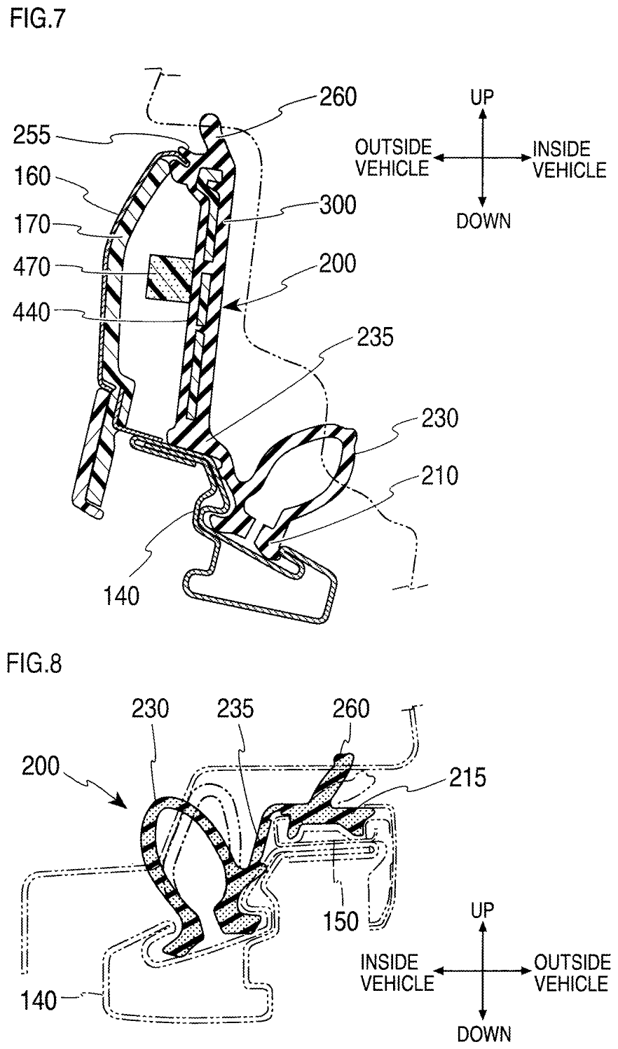

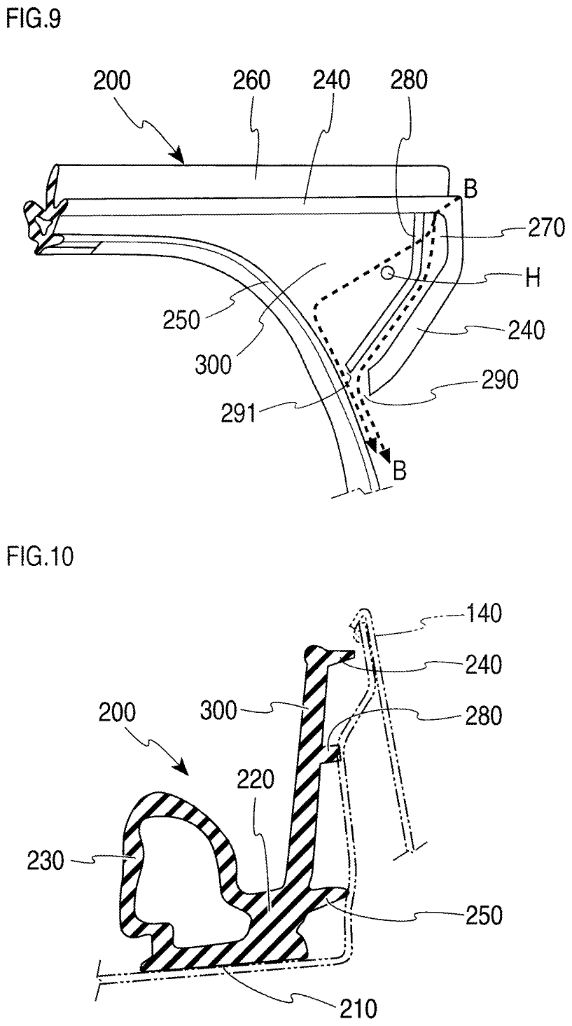

The door weather strip 20 will be described with reference to FIGS. 3 to 6. As shown in FIG. 5, a portion of the door weather strip 20 where the fin portion 24 is formed includes a mounting base portion 21, a hollow seal portion 22, a connecting portion 23, and the fin portion 24. Further, a waterproof bead 29 is formed on the outside of the connecting portion 23.

The upper tip of the fin portion 24 has a rib 26 that is bent to the outside of the vehicle and has a shape in which the tip is split in two. Further, a seal lip 27 is formed at the upper tip of the fin portion 24. On the other hand, below the fin portion 24 (below the insert), a thick portion 28 that comes into elastic contact with the door frame 14 is formed.

In the fin portion 24, a resin insert 25 for improving the shape retention of the fin portion 24 is inserted. The insert may be made of metal, but resin is preferable from the viewpoint of weight reduction.

As shown in FIG. 3, on the mounting surface 44 side of the fin portion 24, there are two clip bases 46 for fixing, to the fin portion 24, clips 45 for mounting the fin portion 24 to an assembly panel 17. The clip bases 46 are formed almost parallel to the seal lip 27.

In the fin portion 24, two drainage lips (a first drainage lip 40 on the upper side and a second drainage lip 41 on the lower side) are formed almost in parallel. The two drainage lips protrude from the mounting surface 44 to the outside of the vehicle, extend in an upward protruding arc shape from the front to the rear and further downward, and have a space between them and a rear end rib 42. Further, in FIG. 5, the angles of the first drainage lip 40 and the second drainage lip 41 protruding from the mounting surface 44 of the fin portion 24 (angle α in FIG. 6) are formed to be the same angle. Further, in the present embodiment, the resin insert 25 also has a shape protruding toward the mounting surface 44 in the portions where the first drainage lip 40 and the second drainage lip 41 are formed. As a result, the strength of the roots of the first drainage lip 40 and the second drainage lip 41 is increased.

The two drainage lips (the first drainage lip 40 on the upper side and the second drainage lip 41 on the lower side) do not have to be formed in parallel from the front to the rear of the vehicle, and the first drainage lip 40 and the second drainage lip 41 do not have the same angle α of protruding from the fin portion 24. Further, the protruding shape of the resin insert 25 may be omitted.

Further, since the second drainage lip 41 is a backup of the first drainage lip 40, the second drainage lip 41 may be omitted if sufficient drainage can be made by the first drainage lip 40.

The length of the second drainage lip 41 protruding from the mounting surface 44 of the fin portion 24 is formed to be longer than that of the first drainage lip 40. This is because the case where the water exceeding the first drainage lip 40 drips from the second drainage lip 41 is taken into consideration.

The first drainage lip 40 formed on the upper side is formed so as to pass between the two clip bases 46. The distance between the tip of the first drainage lip 40 and the clip base 46 at the rear is 2 mm. As a result, it is possible to prevent the tip of the first drainage lip 40 from interfering with the clip base 46, and it is possible to prevent the water on the clip base 46 from passing over the first drainage lip 40 and falling downward.

On the other hand, an end of the second drainage lip 41 at the vehicle front, located below the first drainage lip 40, is integrated with the clip base 46. If there is a space in the fin portion 24, it is desirable to form it below the clip base 46 as in the case of the first drainage lip 40. However, as is clear from FIG. 3, since the second drainage lip 41 covers the entire area of the first drainage lip 40, the water overflowing from the first drainage lip 40 always reaches the second drainage lip 41. Therefore, even if an end of the second drainage lip 41 at the vehicle front is integrated with the clip base 46, no problem occurs.

The fin portion 24 is fabricated using a sponge material of ethylene propylene diene rubber (EPDM).

FIG. 6 is an enlarged view of the Z portion in FIG. 5, which is the first drainage lip 40 when the fin portion 24 is attached to the corner portion 13 of the rear door 10. It is assumed that the tip of the first drainage lip 40 is a tip A, the upper end of the root is an upper end B, the lower end of the root is a lower end C, and the midpoint of a line segment BC connecting the upper end B and the lower end C is a midpoint D. The angle α between a line segment DA, connecting the midpoint D and the tip A, and a horizontal line H is 20 degrees. As described above, the angle α may be in a range between 17 degrees or more and 50 degrees or less.

To attach the fin portion 24 of the door weather strip 20 to the rear door 10, the mounting base portion 21 is fitted into a mounting groove 50 of the door frame 14, and a thick portion 28 at the lower part of the insert is elastically brought into contact with the door frame 14 and is placed thereon. Then, the clips 45 are fitted into the assembly panel 17, and the two-split portion of the rib 26 is inserted into the tip end portion of the frame molding 16. Thereby, the fin portion is attached to the corner portion 13 of the rear door 10. The assembly panel 17 is connected to the door frame 14 via the retainer 15.

Then, when the rear door 10 is closed, the hollow seal portion 22 and the seal lip 27 elastically come into contact with the vehicle body opening edge 18 (two-dot chain line in FIG. 5), and the rear door 10 and the vehicle body opening edge 18 are sealed. Therefore, the seal between the rib 26 and the tip of the frame molding 16 acts as a barrier against infiltration of water from the outside in the fin portion 24.

As shown in FIG. 5, neither the first drainage lip 40 nor the second drainage lip 41 is in contact with the assembly panel 17. The distance between the first drainage lip 40 and the second drainage lip 41 and the assembly panel 17 is preferably set to 1.5 mm or more. This prevents the drainage lips (first drainage lip 40 and second drainage lip 41) and the assembly panel 17 from coming into contact with each other due to the dimensions of each member and an error during assembly, preventing the drainage lips from being inverted downward.

In the upper part, water enters from between the rib 26 and the frame molding 16 and moves downward along the mounting surface 44 of the fin portion 24, but water may drip from between the rib 26 and the frame molding 16. Therefore, it is preferable that the tips of the drainage lips (first drainage lip 40 and second drainage lip 41) are arranged at a position below the contact portion between the rib 26 and the frame molding 16.

Below the rear end rib 42, a drainage recess 43 is formed between the rear end rib 42 and the door frame 14. The drainage of water in the present embodiment is performed in the following manner.

As shown in FIG. 3, water (a1) that has entered from between the rib 26 and the frame molding 16 flows from the rib 26 along the mounting surface 44 of the fin portion 24 and reaches the first drainage lip 40.

The first drainage lip 40 extends from the front to the rear and further downward in an upward protruding arc shape, and in the width direction, the tip A of the first drainage lip 40 protrudes at an angle of 20 degrees with respect to the horizontal line H. Therefore, even if the vehicle tilts in the width direction, the water flows rearward of the vehicle over the first drainage lip 40 (a2).

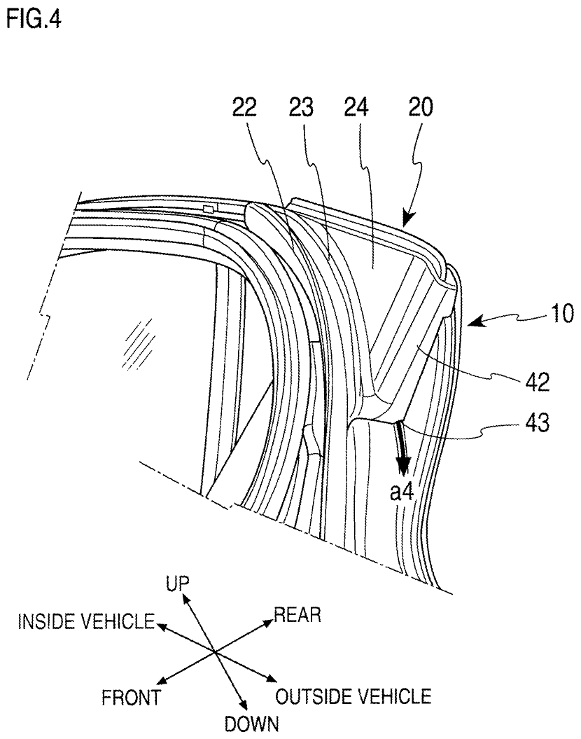

At the tip of the first drainage lip 40 at the rear of the vehicle, a space is formed between the first drainage lip 40 and the rear end rib 42, so that the space allows the water to flow downward on the mounting surface 44 of the fin portion 24 (a3). A drainage recess 43 is formed below the rear end rib 42 of the fin portion 24 so that a gap is formed between the fin portion 24 and the door frame 14 when the fin portion 24 is attached to the door frame 14. Therefore, the water is drained through the drainage recess 43 (a4, FIG. 4).

Further, depending on the momentum and the amount of the infiltrated water, the water that flows from the rib 26 along the mounting surface 44 of the fin portion 24 and reaches the first drainage lip 40 may overflow from the first drainage lip 40. In that case, the overflowing water (a5) flows to the rear of the vehicle on the second drainage lip 41 (a6). At the tip of the second drainage lip 41 at the rear of the vehicle, a space is formed between the second drainage lip 41 and the rear end rib 42 as in the case of the first drainage lip 40. Therefore, due to the space, the water flows downward on the mounting surface 44 of the fin portion 24 (a3) and is drained through the drainage recess 43 in which a gap is formed with the door frame 14 below the rear end rib 42 of the fin portion 24 (a4, FIG. 4).

The practice of the present invention is not limited to the above embodiment, and various changes can be made without departing from the object of the present invention.

In the embodiment of the present invention, the door weather strip 20 is made using EPDM as a material, but may be made using, for example, a dynamically crosslinked thermoplastic elastomer (TPV).

1. A door weather strip comprising a fin portion provided to a corner portion in a rear portion of a door of a motor vehicle, the fin portion being formed by molding and mounted so as to cover inside of the motor vehicle in the corner portion, wherein
on a mounting surface side of the fin portion of the door weather strip,
a drainage lip is provided, the drainage lip protruding from the mounting surface to outside of the motor vehicle and extending in a linear shape or an upward protruding arc shape from front of the motor vehicle to rear of the motor vehicle and further downward, and
the drainage lip does not come into contact with a rear end rib formed on the fin portion at a rear end of the motor vehicle, and a drainage recess is formed between a door frame and the rear end rib.

2. The door weather strip according to claim 1, wherein when the fin portion is mounted on the corner portion of the door, a tip of the drainage lip of the fin portion does not come into contact with an opposite member on the door side.

3. The door weather strip according to claim 1, wherein
in a cross section of the fin portion in a vehicle width direction when the fin portion is mounted on the corner portion of the door,
when the tip of the drainage lip is defined as a tip A,
an upper end of a root of the drainage lip is defined as an upper end B,
a lower end of the root of the drainage lip is defined as a lower end C,
a midpoint of a line segment BC connecting the upper end B and the lower end C is defined as a midpoint D, and
a line segment connecting the midpoint D and the tip A is defined as a line segment DA,
an angle α defined by the line segment DA and a horizontal line is 17 degrees or more
and 50 degrees or less.

4. The door weather strip according to claim 1, wherein a plurality of the drainage lips are formed.

5. The door weather strip according to claim 4, wherein a height of the drainage lip protruding from the mounting surface of the fin portion increases as it goes downward.
